(19) United States
(12) Patent Application Publication
(10) Pub. No.: US 2025/0121872 A1
(43) Pub. Date: Apr. 17, 2025

(54) STEERING YOKE DESIGN FOR INCREASED QUIETNESS

(71) Applicant: Ford Global Technologies, LLC, Dearborn, MI (US)

(72) Inventors: Yungrwei Chen, West Bloomfield, MI (US); Melanie Rodriguez Russell, Ann Arbor, MI (US)

(21) Appl. No.: 18/486,274

(22) Filed: Oct. 13, 2023

(51) Int. Cl. B62D 3/12; B62D 7/22

(52) U.S. Cl. CPC B62D 3/123; B62D 7/226

(57) ABSTRACT

A yoke for a steering assembly that includes a rack shaft and a pinion gear disposed at a gear housing may include a first circumscribing groove extending around an outer diameter of the yoke to receive a first circumscribing O-ring to inhibit noise generation from contact between the yoke and the gear housing, and a first lateral groove disposed at a tip portion of the yoke between the pinion gear and the first O-ring assembly to receive a first lateral O-ring. The first circumscribing groove lies in a first plane substantially perpendicular to an axis of the yoke, and the first lateral groove lies in a second plane substantially perpendicular to the first plane on a first lateral side of the yoke.

### TECHNICAL FIELD

Example embodiments generally relate to vehicle steering technology and, more particularly, relate to a yoke design that reduces any potential for steering rattle, even in rough terrain.

### BACKGROUND

Steering rattle is a noise related issue that can be reported in electric power assisted steering (EPAS) systems. The steering yoke, which is employed to maintain positive engagement between a rack shaft and pinion gear, can sometimes be a source of this unwanted noise. To address this issue, an O-ring assembly comprising one or more O-rings that circumscribe the outer diameter of the steering yoke. Nevertheless, particularly when traversing rough surfaces such as Belgian block or broken concrete, the tip portion of the steering yoke may still generate noise that is perceptible to the driver.

### BRIEF SUMMARY OF SOME EXAMPLES

In accordance with an example embodiment, a yoke for a steering assembly that includes a rack shaft and a pinion gear disposed at a gear housing may be provided. The yoke may include a first circumscribing groove extending around an outer diameter of the yoke to receive a first circumscribing O-ring to inhibit noise generation from contact between the yoke and the gear housing, and a first lateral groove disposed at a tip portion of the yoke between the pinion gear and the first O-ring assembly to receive a first lateral O-ring. The first circumscribing groove lies in a first plane substantially perpendicular to an axis of the yoke, and the first lateral groove lies in a second plane substantially perpendicular to the first plane on a first lateral side of the yoke.

In another example embodiment, a steering assembly for a vehicle may be provided. The steering assembly may include a yoke operably coupled to a rack shaft to maintain lash between the rack shaft and a pinion gear, a gear housing to receive the yoke and at least a portion of the rack shaft and the pinion gear, a first O-ring assembly circumscribing the yoke to inhibit noise generation from contact between the yoke and the gear housing, and a second O-ring assembly disposed at a portion of the yoke between the pinion gear and the first O-ring assembly. A first circumscribing O-ring of the first O-ring assembly may lie in a first plane substantially perpendicular to an axis of the yoke, and a first lateral O-ring of the second O-ring assembly may lie in a second plane substantially perpendicular to the first plane on a first lateral side of the yoke.

In still another example embodiment, a steering assembly for a vehicle may be provided. The steering assembly may include a yoke operably coupled to a rack shaft to maintain lash between the rack shaft and a pinion gear, a gear housing to receive the yoke and at least a portion of the rack shaft and the pinion gear, a first circumscribing groove extending around an outer diameter of the yoke to receive a first circumscribing O-ring to inhibit noise generation from contact between the yoke and the gear housing, and a first lateral groove disposed at a tip portion of the yoke between the pinion gear and the first O-ring assembly to receive a first lateral O-ring. The first circumscribing groove may lie in a first plane substantially perpendicular to an axis of the yoke, and the first lateral groove may lie in a second plane substantially perpendicular to the first plane on a first lateral side of the yoke.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a cross section view of a portion of a rack and pinion steering system in accordance with an example embodiment;

FIG. 2 illustrates a schematic view of noise dampening components associated with a yoke assembly in accordance with an example embodiment;

FIG. 3 shows a perspective view of a yoke in accordance with an example embodiment;

FIG. 4 is a side view of the yoke and various grooves formed therein for receiving O-rings in accordance with an example embodiment;

FIG. 5 is a cross section view of a deepest portion of a lateral groove having an O-ring disposed therein accordance with an example embodiment;

FIG. 6 is a cross section view of a shallowest portion of the lateral groove having the O-ring disposed therein in accordance with an example embodiment; and

FIG. 7 is a perspective view of the yoke having a tapered region proximate to a distal end of a tip portion in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As noted above, especially when traversing rough surfaces such as Belgian block, broken concrete, uneven paving stones and/or the like, the traversal may cause steering rattle noise. The provision of circumscribing O-rings around the yoke has facilitated a general reduction in this noise, but it still occurs in some case. Thus, it may be desirable to address this occurrence, but do so without increasing the complication of assembly.

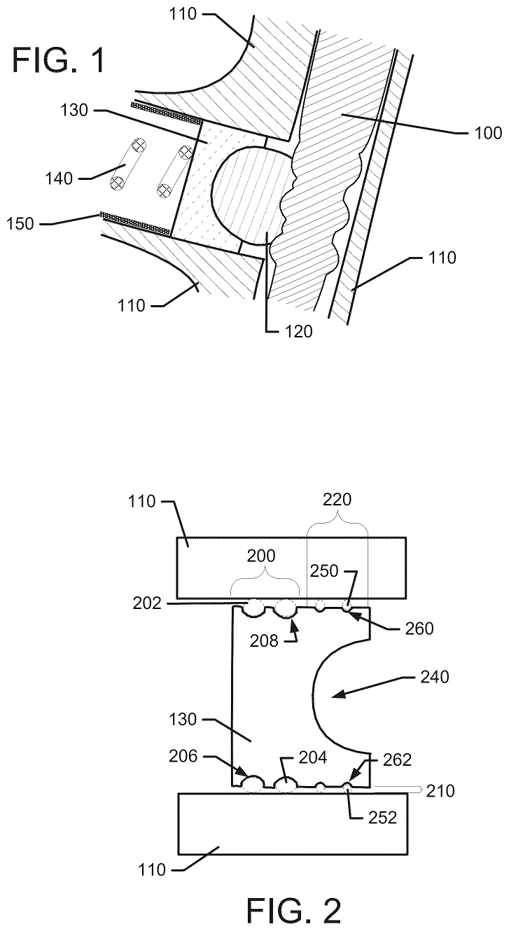

As shown in FIG. 1, a pinion gear 100 may be provided inside a gear housing 110. The pinion gear 100 may be mated with teeth of a rack shaft 120, and it is desirable for the pinion gear 100 to have proper lash with the rack shaft 120 during operation. In this regard, the rack shaft 120 moves (e.g., slides into or out of the page relative to the view in FIG. 1) responsive to the rotation of the steering wheel as initiated by the operator or driver of the vehicle. To keep the pinion gear 100 and the rack shaft 120 mated together as the rack shaft 120 slides, a biasing force is typically applied on the rack shaft 120 by a yoke assembly. The yoke assembly may include a yoke 130, a biasing member 140 and cap 150. In some cases, the cap 150 may be affixed relative to the gear housing 110, and the biasing member 140 (e.g., a helical spring) may push against this affixed base to urge the yoke 130 toward the pinion gear 100 thereby providing biasing to ensure proper lash between the rack shaft 120 and the pinion gear 100. Although not shown in FIG. 1, one or more instances of an O-ring assembly may be provided to circumscribe an outer diameter of the yoke 130 to prevent unwanted rattle noises from occurring in the steering assembly.

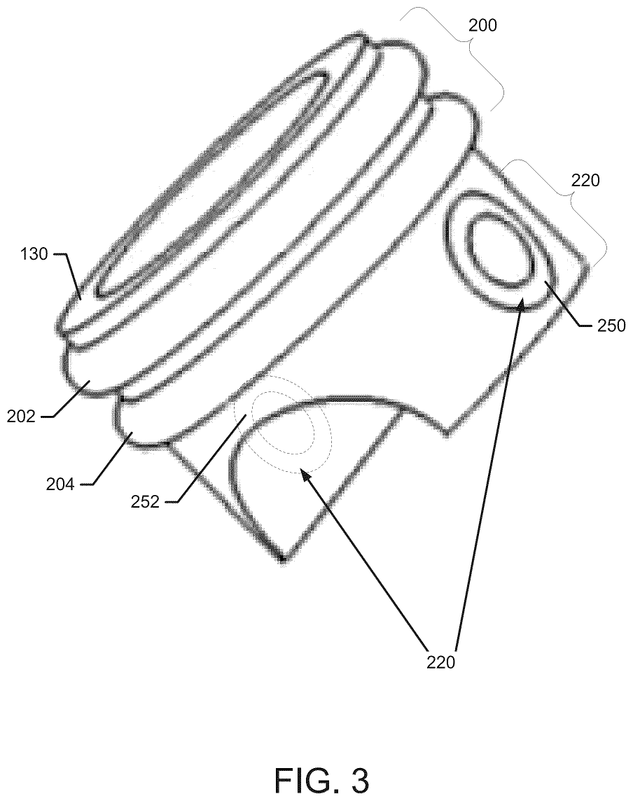

As shown in FIG. 2, a first O-ring assembly 200 may be provided to extend around the outer diameter (i.e., circumscribe) of the yoke 130. The first O-ring assembly 200 of this example embodiment includes two instances of O-rings (e.g., a first circumscribing O-ring 202 and a second circumscribing O-ring 204). However, more or fewer O-rings may be included in the first O-ring assembly 200 in other example embodiments. Each O-ring of the first O-ring assembly 200 may be housed in a corresponding groove around the yoke 130. Thus, for example, the first circumscribing O-ring 202 may be provided in a first circumscribing groove 206 and the second circumscribing O-ring 204 may be provided in a second circumscribing groove 208 spaced apart from the first circumscribing groove 206.

The first O-ring assembly 200 may function to prevent contact between the yoke 130 and the inner bore of the gear housing 110. In this regard, the first O-ring assembly 200 generally maintains a diametrical clearance 210 that is relatively small between the yoke 130 and the inner bore of the gear housing 110. However, by doing so, some amount of friction is introduced in association with assembly since the yoke 130 will have to be installed into the inner bore of the gear housing 110. Grease may be used to reduce the friction in some cases, but it should be appreciated that neither the friction can be reduced to zero, nor can the diametrical clearance be fully maintained under all circumstances using current designs.

In particular, practical experience has determined that a tip portion 220 of the yoke 130 may contact the inner bore of the gear housing 110 when traversing rough or uneven terrain. To reduce the likelihood of occurrence of this phenomenon, example embodiments provide for the addition of a second O-ring assembly 230 closer to the tip portion 220 to prevent contact between the tip portion 220 and the inner bore of the gear housing 110. However, unlike the first O-ring assembly 200, the second O-ring assembly 230 may not circumscribe the yoke 130. At this portion of the yoke 130, an arcuate shaped engagement surface 240 is provided to interface with the rack shaft 120. The yoke 130 is generally a (hollow) cylindrical body, and the engagement surface 240 extends substantially perpendicular to an axis of the yoke 130. The engagement surface 240 is generally therefore formed as a groove that divides the tip portion 220 include two discrete tip members that extend on opposite sides of the groove that forms the engagement surface 240. Circumscribing the yoke 130 is therefore neither possible nor desirable proximate to the tip portion 220 since the portions of the O-rings that are proximate to the groove of the engagement surface 240 would be loose and exposed. Moreover, full extension of O-rings around the tip portion 220 would have the potential for increasing friction to an undesirable level by making assembly much more difficult. Accordingly, the second O-ring assembly 230 is provided with distinct O-rings that each lie in a plane that extends substantially perpendicular to the planes in which the first O-ring assembly 200 lie. However, as will be discussed in greater detail below, the second O-ring assembly 230 is also structured to balance reducing the introduction of friction associated with contact between the second O-ring assembly 230 and the inner bore of the gear housing 110 against the provision of increased damping to prevent contact between the tip portion 220 and the inner bore of the gear housing 110.

The second O-ring assembly 230 includes a first lateral O-ring 250 and a second lateral O-ring 252 (represented in dashed lines in FIG. 3 since it is located on the opposite face of the tip member farthest from the viewer, and therefore not directly visible in FIG. 3). The term “lateral” used in reference to the first and second lateral O-rings 250 and 252 refers to the location of the first and second lateral O-rings 250 and 252 on opposing external lateral sides of the tip members of the tip portion 220. The first lateral O-ring 250 may be located in a first lateral groove 260 on a first external lateral side of the tip portion 220, and the second lateral O-ring 252 may be located in a second lateral groove 262 on a second external lateral side of the tip portion 220 (opposite the first external lateral side of the tip portion 220). The first and second lateral grooves 260 and 262 may substantially mirror each other on opposite sides of the yoke 130

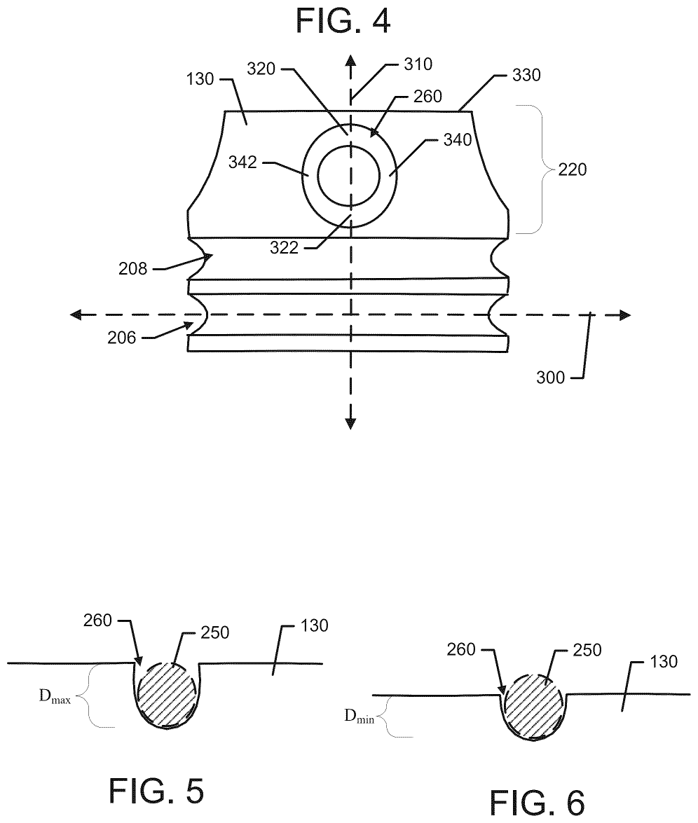

FIG. 4 illustrates a side view of the yoke 130 of an example embodiment. FIG. 4 also shows a plane 300 that bisects the first circumscribing groove 206 perpendicular to its axis. The plane 300 would also bisect the first circumscribing O-ring 202 (perpendicular to its axis) responsive to placement of the first circumscribing O-ring 202 into the first circumscribing groove 206. The plane 300 extends into the page, and is substantially perpendicular to an axis 310 of the yoke 130 (which is also coaxial with the first and second circumscribing O-rings 202 and 204 when located in the first and second circumscribing grooves 206 and 208, respectively). The plane 300 is also parallel to a similar plane bisecting the second circumscribing groove 208 perpendicular to its axis.

The first lateral groove 260 is visible in FIG. 4, but it should be appreciated that the second lateral groove 262 mirrors the first lateral groove 260 on the opposite (and not visible) side of the yoke 130. The first lateral groove 260 is formed into the lateral side of the tip portion 220. In an example embodiment, the first lateral groove 260 may be formed by machining in such a way that material is removed from the lateral side of the yoke 130 at the tip portion 220. The machining process is generally performed with a material removal device that presents a flat or planar cutting head or surface against the lateral side of the yoke 130. Since the lateral side of the yoke 130 is curved, the flat or planar cutting head used for material removal will tend to form the first lateral groove 260 (and the second lateral groove 262 when it is formed) to have a different depth at different portions of the groove formed.

In this regard, the deepest portion of the first lateral groove 260 will be the portion of the groove through which a line parallel to the axis 310 passes. Notably, if a plane were drawn including both the axis 310 and the line parallel to the axis 310, such plane would bisect the first lateral groove 260 and include its axis. FIG. 5 illustrates a cross section view of the first lateral groove 260 at this location, which is also indicated at deepest point 320 on FIG. 4. Notably, deepest point 322, which is also along the line parallel to the axis 310 bisecting the first lateral groove 260 is also indicated in FIG. 4, and would have the same cross section view as that of FIG. 5 (and the same depth). In an example embodiment, the first lateral groove 260 may be formed to a variable depth (dependent on position) where the maximum depth (Dₘₐₓ) is substantially equal to a cross sectional diameter or thickness of the first lateral O-ring 250. Thus, as shown in FIG. 5, no portion (or very little based on design tolerances) of the first lateral O-ring 250 may extend out of the first lateral groove 260 at the portion of the first lateral groove 260 that is closest to a distal end 330 of the tip portion 220 (relative to a main body portion of the yoke 130) or the portion of the first lateral groove 260 that is farthest from the distal end 330 of the tip portion 220.

The shallowest portion of the first lateral groove 260 will be the portions of the groove that are spaced farthest apart from a plane including the axis 310 of the yoke 130 and the axis of the first lateral groove 260. The shallowest portions of the first lateral groove 260 are indicated at shallowest points 340 and 342 in FIG. 4. FIG. 6 shows a cross section view of the first lateral groove 260 at shallowest point 340. Since the first lateral groove 260 is shallower at this portion of the groove, the first lateral O-ring 250 extends partially out of the first lateral groove 260, as shown in FIG. 6. Thus, it can be appreciated that the minimum depth (Dₘᵢₙ) of the first lateral groove 260 is less than the thickness of the first lateral O-ring 250. The difference between the maximum depth (Dₘₐₓ) and minimum depth (Dₘᵢₙ) of the first lateral groove 260 may vary in different embodiments depending on the relationship between the outer diameter of the yoke 130 and the outer diameter of the first lateral groove 260. However, in some embodiments, when the maximum depth (Dₘₐₓ) is about equal to the thickness of the first lateral O-ring 250, the minimum depth (Dₘᵢₙ) may be such that between about 50% and 20% of the thickness of the first lateral O-ring 250 extends out of the first lateral groove 260 at the point of minimum depth (Dₘᵢₙ).

In an example embodiment, the outer diameter of the first and second lateral O-rings 250 and 252 may be about ½ inch, and a thickness (or cross sectional diameter) thereof may be about 3/32 inch (i.e., 2.38 mm). Since the maximum depth (Dₘₐₓ) of the first and second lateral grooves 260 and 262 is about equal to the thickness of the first and second lateral O-rings 250 and 252, the maximum depth (Dₘₐₓ) of the first and second lateral grooves 260 and 262 for this example may be set to about 2.4 mm at deepest points 320 and 322 in FIG. 4. Meanwhile, for a ½ inch outer diameter of the first and second lateral O-rings 250 and 252, that places both the shallowest points 340 and 342 ¼ inch away from a line connecting the deepest points 320 and 322. Given the curvature of the outer diameter of the yoke 130, and the parameters noted above, the first and second lateral grooves 260 and 262 may have minimum depth (Dₘᵢₙ) of about 1.38 mm, thereby leaving about 0.98 mm of the first and second lateral O-rings 250 and 252 exposed (i.e., extending out of the first and second lateral grooves 260 and 262). The diametrical clearance 210 may be about 50 um on average (e.g., from 20 mc to 81 mc). Thus, 0.98 mm exposed (or 980 mc) can be related to the diametrical clearance 210 of about 50 mc to determine that the amount of exposed O-ring in this example may be about 980 mc/50 mc or a ratio of about 19.6:1 (or 20:1). However, it should be appreciated that adjustments may be made to the depth of the first and second lateral grooves 260 and 262 in order to determine how much of the first and second lateral O-rings 250 and 252 is exposed at each of the deepest points 320 and 322, and shallowest points 340 and 342. Thus, for example, the maximum depth (Dₘₐₓ) of the first and second lateral grooves 260 and 262 may be reduced to leave some amount of the first and second lateral O-rings 250 and 252 exposed at the deepest points 320 and 322 (and exposing correspondingly more of the first and second lateral O-rings 250 and 252 exposed at the shallowest points 340 and 342) to provide more damping in cases where aggressive action is taken to reduce rattle noise. In such cases, the amount of exposed O-ring diameter may range between zero (when maximum depth (Dₘₐₓ) is equal to or greater than O-ring thickness) and 25 times the diametrical clearance 210 at deepest points 320 and 322 and may range between about 10 and 50 times the diametrical clearance 210 at shallowest points 340 and 342.

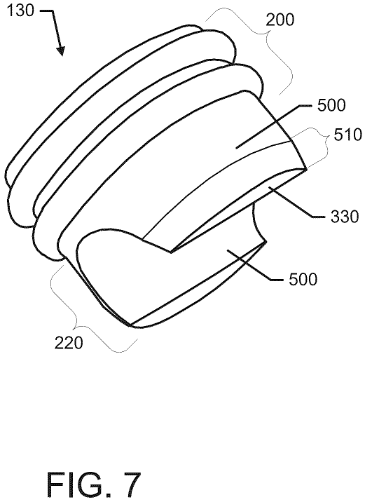

Other actions to mitigate noise production may also be taken as an alternative to, or in addition to the modifications noted above. In this regard, for example, the outer diameter of the yoke 130 may be reduced slightly at the distal end 330 of the tip portion 220. FIG. 7 illustrates one of the tip members 500 of the yoke 130 having a tapered region 510 that extends to the distal end 330. Although the amount of taper and the length over which the taper is provided may vary, in some embodiments, the outer diameter may be reduced by between about 5% and 10% and the reduction may occur over any length up to as much as 25% of the length of the yoke 130. While the reduction in FIG. 7 is shown as a gradual taper (starting at 0% and increasing linearly to 10% at the distal end 330), in some embodiments the tapered region 510 may all have the same reduced outer diameter, and a prompt change or ridge may define a border between the tapered region 510 and remaining portions of the yoke 130. Although FIG. 7 does not expressly show the inclusion of lateral O-ring grooves, such grooves may be added in some examples.

Example embodiments may therefore provide a steering assembly for a vehicle. The steering assembly may include a yoke operably coupled to a rack shaft to maintain lash between the rack shaft and a pinion gear, and a gear housing to receive the yoke and at least a portion of the rack shaft and the pinion gear. In one example embodiment the steering assembly may further include a first O-ring assembly circumscribing the yoke to inhibit noise generation from contact between the yoke and the gear housing, and a second O-ring assembly disposed at a portion of the yoke between the pinion gear and the first O-ring assembly. A first circumscribing O-ring of the first O-ring assembly may lie in a first plane substantially perpendicular to an axis of the yoke, and a first lateral O-ring of the second O-ring assembly may lie in a second plane substantially perpendicular to the first plane on a first lateral side of the yoke. In an alternative example embodiment, the steering assembly may further include a first circumscribing groove extending around an outer diameter of the yoke to receive a first circumscribing O-ring to inhibit noise generation from contact between the yoke and the gear housing, and a first lateral groove disposed at a tip portion of the yoke between the pinion gear and the first O-ring assembly to receive a first lateral O-ring. The first circumscribing groove may lie in a first plane substantially perpendicular to an axis of the yoke, and the first lateral groove may lie in a second plane substantially perpendicular to the first plane on a first lateral side of the yoke.

The steering assembly of some embodiments (or more specifically the yoke of the steering assembly) may include additional features, modifications, augmentations and/or the like to achieve further objectives or enhance performance of the device. The additional features, modifications, augmentations and/or the like may be added in any combination with each other. Below is a list of various additional features, modifications, and augmentations that can each be added individually or in any combination with each other. For example, the second O-ring assembly may include the first lateral O-ring disposed on the first lateral side of the yoke and a second lateral O-ring located at a second lateral side of the yoke opposite the first lateral side. In an example embodiment, the first and second lateral O-ring assemblies may be disposed in a first lateral groove formed in the first lateral side of the yoke and a second lateral groove formed in the second lateral side of the yoke, respectively. In some cases, a depth of the first lateral groove may decrease as distance from a plane passing through an axis of the yoke and an axis of the first lateral groove increases. In an example embodiment, a maximum depth of the first lateral groove may be set relative to a thickness of the first lateral O-ring such that an amount of the first lateral O-ring that extends out of the first lateral groove at a point of the maximum depth is between about 0 and 25 times an average diametrical clearance between the first lateral side of the yoke and an inner bore of the gear housing. In some cases, a minimum depth of the first lateral groove may be set relative to a thickness of the first lateral O-ring such that an amount of the first lateral O-ring that extends out of the first lateral groove at a point of the minimum depth is between about 10 and 50 times an average diametrical clearance between the first lateral side of the yoke and an inner bore of the gear housing. In an example embodiment, a maximum depth of the first lateral groove may be substantially equal to a thickness of the first lateral O-ring and a minimum depth of the first lateral groove may be such that between about 50% and 20% of the thickness of the first lateral O-ring extends out of the first lateral groove at a point of the minimum depth. In some cases, the tip portion of the yoke may include a tapered portion, and the tapered portion may define an outer diameter reduction for the yoke of between about 5% and 10% over less than 25% of the tip portion proximate to the distal end.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A steering assembly for a vehicle, the steering assembly comprising:
a yoke operably coupled to a rack shaft to maintain lash between the rack shaft and a pinion gear;
a gear housing to receive the yoke, and at least a portion of the rack shaft and the pinion gear;
a first O-ring assembly circumscribing the yoke to inhibit noise generation from contact between the yoke and the gear housing; and
a second O-ring assembly disposed at a portion of the yoke between the pinion gear and the first O-ring assembly,
wherein a first circumscribing O-ring of the first O-ring assembly lies in a first plane substantially perpendicular to an axis of the yoke, and a first lateral O-ring of the second O-ring assembly lies in a second plane substantially perpendicular to the first plane on a first lateral side of the yoke.

2. The steering assembly of claim 1, wherein the second O-ring assembly includes the first lateral O-ring disposed on the first lateral side of the yoke and a second lateral O-ring located at a second lateral side of the yoke opposite the first lateral side.

3. The steering assembly of claim 2, wherein the first and second lateral O-ring assemblies are disposed in a first lateral groove formed in the first lateral side of the yoke and a second lateral groove formed in the second lateral side of the yoke, respectively.

4. The steering assembly of claim 3, wherein a depth of the first lateral groove decreases as distance from a plane passing through an axis of the yoke and an axis of the first lateral groove increases.

5. The steering assembly of claim 4, wherein a maximum depth of the first lateral groove is set relative to a thickness of the first lateral O-ring such that an amount of the first lateral O-ring that extends out of the first lateral groove at a point of the maximum depth is between about 0 and 25 times an average diametrical clearance between the first lateral side of the yoke and an inner bore of the gear housing.

6. The steering assembly of claim 4, wherein a minimum depth of the first lateral groove is set relative to a thickness of the first lateral O-ring such that an amount of the first lateral O-ring that extends out of the first lateral groove at a point of the minimum depth is between about 10 and 50 times an average diametrical clearance between the first lateral side of the yoke and an inner bore of the gear housing.

7. The steering assembly of claim 4, wherein a maximum depth of the first lateral groove is substantially equal to a thickness of the first lateral O-ring and a minimum depth of the first lateral groove is such that between about 50% and 20% of the thickness of the first lateral O-ring extends out of the first lateral groove at a point of the minimum depth.

8. The steering assembly of claim 1, wherein the tip portion of the yoke comprises a tapered portion, and
wherein the tapered portion defines an outer diameter reduction for the yoke of between about 5% and 10% over less than 25% of the tip portion proximate to the distal end.

9. A steering assembly for a vehicle, the steering assembly comprising:
a yoke operably coupled to a rack shaft to maintain lash between the rack shaft and a pinion gear;
a gear housing to receive the yoke, and at least a portion of the rack shaft and the pinion gear;
a first circumscribing groove extending around an outer diameter of the yoke to receive a first circumscribing O-ring to inhibit noise generation from contact between the yoke and the gear housing; and
a first lateral groove disposed at a tip portion of the yoke between the pinion gear and the first O-ring assembly to receive a first lateral O-ring,
wherein the first circumscribing groove lies in a first plane substantially perpendicular to an axis of the yoke, and the first lateral groove lies in a second plane substantially perpendicular to the first plane on a first lateral side of the yoke.

10. The steering assembly of claim 9, further comprising a second lateral groove disposed on a second side of the yoke opposite the first lateral side to receive a second lateral O-ring.

11. The steering assembly of claim 10, wherein a depth of the first lateral groove decreases as distance from a plane passing through an axis of the yoke and an axis of the first lateral groove increases.

12. The steering assembly of claim 11, wherein a maximum depth of the first lateral groove is set relative to a thickness of the first lateral O-ring such that an amount of the first lateral O-ring that extends out of the first lateral groove at a point of the maximum depth is between about 0 and 25 times an average diametrical clearance between the first lateral side of the yoke and an inner bore of the gear housing.

13. The steering assembly of claim 11, wherein a minimum depth of the first lateral groove is set relative to a thickness of the first lateral O-ring such that an amount of the first lateral O-ring that extends out of the first lateral groove at a point of the minimum depth is between about 10 and 50 times an average diametrical clearance between the first lateral side of the yoke and an inner bore of the gear housing.

14. The steering assembly of claim 11, wherein a maximum depth of the first lateral groove is substantially equal to a thickness of the first lateral O-ring and a minimum depth of the first lateral groove is such that between about 50% and 20% of the thickness of the first lateral O-ring extends out of the first lateral groove at a point of the minimum depth.

15. The steering assembly of claim 9, wherein the tip portion of the yoke comprises a tapered portion, and
wherein the tapered portion defines an outer diameter reduction for the yoke of between about 5% and 10% over less than 25% of the tip portion proximate to the distal end.

16. A yoke for a steering assembly that includes a rack shaft and a pinion gear disposed at a gear housing, the yoke comprising:
a first circumscribing groove extending around an outer diameter of the yoke to receive a first circumscribing O-ring to inhibit noise generation from contact between the yoke and the gear housing; and
a first lateral groove disposed at a tip portion of the yoke between the pinion gear and the first O-ring assembly to receive a first lateral O-ring,
wherein the first circumscribing groove lies in a first plane substantially perpendicular to an axis of the yoke, and the first lateral groove lies in a second plane substantially perpendicular to the first plane on a first lateral side of the yoke.

17. The yoke of claim 16, wherein a depth of the first lateral groove decreases as distance from a plane passing through an axis of the yoke and an axis of the first lateral groove increases.

18. The yoke of claim 17, wherein a maximum depth of the first lateral groove is set relative to a thickness of the first lateral O-ring such that an amount of the first lateral O-ring that extends out of the first lateral groove at a point of the maximum depth is between about 0 and 25 times an average diametrical clearance between the first lateral side of the yoke and an inner bore of the gear housing, and
wherein a minimum depth of the first lateral groove is set relative to a thickness of the first lateral O-ring such that an amount of the first lateral O-ring that extends out of the first lateral groove at a point of the minimum depth is between about 10 and 50 times an average diametrical clearance between the first lateral side of the yoke and an inner bore of the gear housing.

19. The yoke of claim 17, wherein a maximum depth of the first lateral groove is substantially equal to a thickness of the first lateral O-ring and a minimum depth of the first lateral groove is such that between about 50% and 20% of the thickness of the first lateral O-ring extends out of the first lateral groove at a point of the minimum depth.

20. The yoke of claim 16, wherein the tip portion of the yoke comprises a tapered portion, and
wherein the tapered portion defines an outer diameter reduction for the yoke of between about 5% and 10% over less than 25% of the tip portion proximate to the distal end.
